(19) United States
(12) Patent Application Publication
(10) Pub. No.: US 2004/0211915 A1
(43) Pub. Date: Oct. 28, 2004

(54) Method for the determination of substances in a liquid or gaseous sample

(76) Inventor: Markus Klotz, Bad Liebenzell (DE)

Correspondence Address: KLAUS J. BACH, 4407 TWIN OAKS DRIVE, MURRYSVILLE, PA, 15668, US

(21) Appl. No.: 10/850,097

(22) Filed: May 20, 2004

Related U.S. Application Data
(63) Continuation-in-part of application No. PCT/EP02/09123, filed on Aug. 14, 2002.

(30) Foreign Application Priority Data
Nov. 20, 2001 (DE) 101 56 612.3

(51) Int. Cl. G01N 15/02; G01N 21/64

(52) U.S. Cl. 250/459.1; 356/335

(57) ABSTRACT

In a method for the determination of substances in a liquid or gaseous sample wherein a number representing the number of substances of different size classes assumed to be in the sample is selected, micro-particles with binding partners of one of the substances assumed to be in the sample are added to the sample so that a hybridization takes place in which binding partners are joined to a substance-specific agent of the substance in the sample if such substance is present such that the size of the micro-particle increases and the amount of enlarged micro-particles in the sample is determined as an indication for the actual presence of the substance assumed to be present in the sample.

This is Continuation-In-Part Application of international application PCT/EP02/09123/filed Aug. 14, 2002 and claiming the priority of German application 101 56 612.3 filed Nov. 20, 2001.

### BACKGROUND OF THE INVENTION

The invention relates to a method for the determination of substances in a liquid or gaseous sample.

Such substances or substance-specific agents may, on one hand, be amounts of molecular compounds or, respectively, material amounts and, on the other hand, —in the area of biology and medicine—also molecular pathogens, that is, bacteria, viruses, fungi, parasites, but also for example antibodies, proteins, genetic information etc. in the micro and nano-size range.

In this area, because of the advances in the knowledge of the genetically coded information and the scientific advances in the research of biologic-medical systems, the need for powerful diagnoses or, respectively, analysis methods for the determination of such substances in the respective samples is greatly increased.

The miniaturized micro-titer plates used so far for that purpose with for example up to 1536 sample chambers as well as the highly integrated so-called “biochips” with up to 100000 matrix elements require each time-consuming preparations and extensive equipment. In the first case, two or several different chemical reagents must be dispensed into a sampling chamber and then subsequently, interactions between the reaction partners, which result in an immobilization of a reaction partner on the surface of the chamber, the so-called hybridization, must be determined by standardized analytical measuring techniques (absorption, fluorescence, luminescence, etc.).

With a “biochip”, discrete matrix elements, to which by expensive procedures, such as imprinting, nucleic acids or proteins have been applied, are incubated with the sample to be examined and the hybridization reaction is initiated by heating. Already these preparations require appropriate experience and expensive equipment. The subsequent reactions cannot be directly influenced so that no quality control is possible.

It is the object of the present invention to provide a method for the determination of substances of the type mentioned above which may be present in a liquid or gaseous sample in a single analysis procedure without the need for special experience and particularly without the need for expensive equipment and furthermore, wherein such determinations can be performed in a mobile manner that is at any desired place.

### SUMMARY OF THE INVENTION

In a method for the determination of substances in a liquid or gaseous sample wherein a number representing the number of substances of different size classes assumed to be in the sample is selected, micro-particles with binding partners of one of the substances assumed to be in the sample are added to the sample so that a hybridization takes place in which binding partners are joined to a substance-specific agent of the substance in the sample if such substance is present such that the size of the micro-particle increases and the amount of enlarged micro-particles in the sample is determined as an indication for the actual presence of the substance assumed to be present in the sample.

The invention is based on the use of commercially available preferably spherical micro-particles, which, with a size-distribution of <1% are almost homogeneous and preferably consist of latex (=cross-linked polysterol, possibly also polypropylene) with a diameter in size classes of for example 2 μm to 150 μm, which however may also be in the millimeter as well as in the nanometer range. These micro-particles, which can be ordered by catalogue, may be ordered provided already with so-called binding partners, which are capable each of firmly attaching to themselves one of the above-mentioned substance-specific agents representing the substance to be determined. In this way, a layer is formed on the individual microparticles so that their size increases although only in the molecular range.

On the other hand, highly precise measurement apparatus preferably operating on the basis of laser-optical procedures are commercially available by which for example the size of such micro-particles, but also the above-referred to molecular increase in size resulting from the binding reactions can be determined at least in liquid substrates with high accuracy (better than 2%). With a micro-particle density of up to 200,000 micro-particles/ml accordingly 20 to 100 and more differently sized micro-particles or, respectively different micro-particle size classes can be distinguished.

With this background, the present invention is based on the concept of detecting the presence of assumed substances assumed to be in a sample in such a way that a certain defined size class of such micro-particles is assigned to each of those substances in an abstract way. If then a mixture of the so selected micro-particles, which are substance specific according to size classes and provided with the binding partners for the respective substances, is added to the sample, the binding partners of the various micro-particles of a certain size class attach to themselves a particular substance-specific agent of the substance actually present in the sample whereby the size of the micro-particle hybridized in this way increases.

If then in a sample, micro-particles of a size larger than according to the abstract assignment for the given initial size classes are measured, it is apparent that the substances assigned to the respective size classes are actually present in the sample. Consequently, the sample is not directly analyzed for the presence of certain substance-specific agents, but, by way of determining a size increase of microparticles of a defined initial size, their presence is indirectly derived. With a proper selection of the micro-particle size classes, that is their respective distances from each other, it is not important which absolute size increase the individual micro-particles experience.

For definite measuring results, the micro-particle size classes to be selected should be distinct with respect to the order of size of the substances to be determined or, respectively, the substance-specific agents. It is for example possible to avoid that, by the binding of an excessive amount of substance-specific agents to a micro-particle, the next larger micro-particle class is reached which is assigned to another substance assumed to be present in the sample.

On the other hand, with the abstract size classification, it must be taken into consideration that the micro-particle size classes are so selected that, by the binding of substance-specific agents to the micro-particles of the respective assigned micro-particle size class, the micro-particle size increases so as to be measurable at least by laser optics.

For measuring the increase in size of micro-particles, the sample is, after the hybridization phase, conducted by way of a measuring passage into a measuring cuvette, wherein a light beam illuminating the measuring passage is more or less weakened depending on the size of the hybridized or not hybridized micro-particles passing subsequently through the measuring passage. The light attenuation is measured by a light attenuation sensor and converted to a micro-particle size signal for example in the form of a current or voltage signal. The sample to be analyzed including the microparticles passes through the measuring passage in an individualized manner sufficient for the necessary measuring security which is ensured with the mentioned micro-particle density of 200,000 micro-particles/ml.

### EXAMPLE

If for example micro-particles of a size of 2 μm with recognition sequences (=antibodies) for a German Measles infection, other micro-particles of a size of 50 μm with molecules for hepatitis-A and further micro-particles of the size of 100 μm with sequences for the recognition of the HIV virus are prepared as described above, it can be determined with a single sample analysis wherein, in accordance with the invention, hybridized micro-particles are measured for determining a size increase, whether a person had German measles and whether furthermore one of the two other infections are present.

The method according to the invention has the following characteristics:

No complicated charging (“spotting”) of matrix structures with discrete matrix elements is necessary as it is with the biochips mentioned earlier, since, in accordance with the invention, different micro-particle sizes replace the matrix structure so that no complicated structural/spatial coordination is necessary;

different micro-particle materials such as latex, plastics, glass or even metals may be used; consequently, different micro-particle materials can be used for specific charging and/or binding conditions (hybridization conditions) of the reaction partners for application to the micro-particles, wherein the reaction partners ensure the binding of for example molecules of a substance to be identified in the sample to be analyzed to micro-particles of different sizes;

the micro-particles of the different size classes can be provided, in contrast for example to the biochips treatment, separately in so-called “preparations” for additionally automatically proceeding steps, which ensures an improved quality, and the quality is consequently also controllable; this substance-based preparation of micro-particles is offered in the meantime as a service by respective enterprises so that, for each sample analysis to be performed, the required prepared micro-particles can be ordered from a catalog; this substantially simplifies the analysis preparation and makes it inexpensive and fast, since, after the easy introduction of the prepared micro-particles of different size classes which occurs normally manually with a pipette from a storage glass for example, the sample analysis can be directly performed;

in this way also, the quality control of the various charges is ensured and the combination of the analysis preparations can be individually adapted;

the preparations can occur in any micro-containers which, at the same time, may be used for measuring;

the specific analysis preparations for the analysis of a sample with assumed substances may be, depending on the particular case, mixtures of micro-particles of different micro-particle size classes which are provided depending on the particular case and which, as already mentioned earlier, may simply be taken, using for example a pipette, from a microparticle storage glass and added to the sample;

the hybridization of the selected micro-particles with molecules of the substances contained in the sample occurs in a normal cuvette, for example in the measuring cuvette in accordance with temperature control conditions;

washing procedures required in the biochip technology are not needed; if however washing procedures are employed, they are very simple and can be performed automatically;

the preparations contained in the measuring cuvette can be analyzed directly with little efforts;

in the preparations to be analyzed, immobilized reaction partners, for example medically-diagnostically relevant reactions (on DNA- or protein basis) can be detected rapidly and flexibly, at low expenses and without expensive equipment (no pipette apparatus; no robots for the application of reaction partners, no biochip reader) without chips and geometric assignments while quality controls are-possible (also for certification requirements);

all liquids or gases being transparent in the measuring cuvette under measuring conditions can be analyzed for the molecular substances contained therein, for example, also oil for water possibly contained therein or for additional components such as additives, etc., and also chemicals;

accordingly, also gaseous media can be used as sample substrates for the substance analysis according to the invention;

users can, with corresponding charges of micro-particles available from the manufacturer in precise size classes <1% prepare their own analysis kits, or as already mentioned, they can buy finished kits for direct use; therefore the diagnosis procedures in the molecular medicine are substantially simplified which leads to a wider use of such diagnostic tests or analyses and the associated diagnostic determinations improving the security of the physician and the patient;

all process-based steps can be performed in micro cuvettes in the common wet chemical procedure;

for the apparatus-technical realization of the sample analysis according to the invention, compact equipment which can be easily transported and therefore advantageously be used also in a mobile way wherever needed, for example, facilitates the use by a doctor during a house visit or by nurses in connection with the examination at the hospital bedside; the analysis results, that is which substances were found to be present in the sample, can be indicated for example by naming them, for example illnesses, on a corresponding display; to this end, for example, software may be provided which evaluates the association selection between micro-particle size classes and assumed substance originally inputted into the evaluation apparatus based on the respective micro-particle size increases measured.

If it appears necessary substance-specific agents which are not bound to a binding partner can be removed from the sample in a kind of washing procedure in order to provide for an increased purity of the sample during the measuring procedure.

If by the binding of substance-specific agents in the hybridization phase to the binding partners of micro-particles of a certain class size, no sufficiently large size increase of these micro-particles can be obtained so that no reliable size measurement can be obtained, an additional increase in size of the construct formed already by a micro-particle and the substance-specific agents attached thereto in the following way: For an additional hybridization phase corresponding to substance-specific binding partners for the respective micro-particle size class are added to the sample which now however are bound by the substance-specific agents bound already by the binding partners of the respective micro-particles and, in this way, form a kind of second layer on those microparticles.

For the determination of pathogens assumed to be present in a sample, preferably corresponding antibodies are used as binding partners for their binding to the respective selected micro-particles.

Vice versa for the detection of antibodies in a sample preferably the corresponding pathogens are used as microparticle binding partners.

If the results of the increased size of measurements of hybridized micro-particles of a certain size class should not be sufficiently significant with respect to those of other size classes to be able to determine therefrom the presence of a particular substance in the sample to be examined, the size-increase measurement can be advantageously supplemented by a further hybridization-dependent obtainable measurement value. This can be achieved for example by light emitted from a hybridized particles based on a corresponding preparation.

A combination of such two measurements for sample analyses may also be necessary for example because of the distances of the available micro-particle size classes from one another, or, expressed otherwise, to facilitate the analysis with such small-distance spacings between the size classes.

To this end, the size-class dependent micro-particles already prepared with substance-specific binding partners may be charged on its surface additionally with a second, different reaction partner, which is treated to be fluorescent, that is a so-called “marker”. If there is an excessive amount of markers as there might be with non-bound substance-specific agents, they are removed easily by an automatic washing procedure which, in contrast to biochips for example, can easily be performed.

The second measurement value may for example be a fluorescent light generated by means of an excitation light beam, preferably also a laser light beam which has a wavelength different from that of the excitation light and which is directed onto a corresponding second measuring sensor.

With these two signals, which are intertwined in a cross-related evaluation, it could then be determined that a certain substance believed to be in the sample in accordance with the micro-particle preparation is actually present in the solution. In that case, consequently, only the fluorescence light signal added to the micro-particle size signal would permit the conclusion that a micro-particle of a certain size class has actually been hybridized with substance-specific agents as assigned first in an abstract way by its size class but then in a concrete manner by a size class specific preparation with the substance assigned to the respective binding partners whereby, by way of the micro-particle size signal, it is immediately clear exactly which substance is involved.

For this purpose, the two measuring sensors must be able to detect the size of individual micro-particles with high accuracy and also the fluorescence light which is emitted by the micro-particle when illuminated and which possibly has up to three and more different frequencies, possibly in a simultaneous manner for the subsequent evaluation.

The two measurement values, instead of being detected, if appropriate simultaneously, may also be detected subsequently with very short time spacing. To this end, for example, two different laser light beams may be directed with a small spatial spacing between them onto the measurement channel of the measuring cuvette, so that the micro-particles pass first one of the beams, and with a time difference corresponding to the spatial distance of the laser beams from one another, the second laser beam which may have a wavelength different from that of the first beam.

The measuring values “micro-particle size” and “fluorescence light emission” determined in this way one after the other from a hybridized micro-particle could then be assigned to each other in spite of the time spaced detection for the evaluation in order to determine the substance.

With regard to a clearly detectable fluorescence light signal, it would be advantageous if the micro-particles added in each case to a sample are provided each with as many markers as possible in order to generate in this way a highly intensive fluorescent light. As already mentioned, to this end, the micro-particles should be spherical and preferably consist of latex. Then for the detection of this excited light a light threshold value could be defined which is not exceeded by the excitation of only slightly fluorescent other components contained in the sample so that these components would not be detected and counted.

Prior fluorescence methods are based on the same biochemical principle but they use a carrier matrix with a rigid plastic surface for example micro-titer plates or possibly highly integrated biochips of complicated design.

It is conceivably also possible to use, under certain circumstances, the substance detection method according to the invention with micro-particles which, prepared for that purpose, are inserted into the human body, possibly only after corresponding liquid samples have been taken or hybridized micro-particles have been extracted from liquids discharged in the natural way.

It is noted that the possibly natural presence of substances to be determined in specific liquids such as blood or other liquids or also gases to be analyzed in accordance with the invention may be soiled or contaminated so that it may be necessary to extract the prepared micro-particles after hybridization with corresponding substance molecules or other substance-specific agents from the respective sample for example by washing, filtering or centrifuging in order to introduce them only afterwards into a suitable pure substrate of appropriate viscosity for the analysis according to the invention by size—and possibly fluorescence light measurements.

In addition to measuring the size of the micro-particles, which pass through the measuring channel sufficiently individually, the micro-particles may at the same time be counted in order to obtain information concerning the concentration of a substance to be detected in a sample.

With the method according to the invention, a substantial amount of time and material can be saved and the equipment requirements can be reduced by the elimination of time-consuming, complicated measurements by the predetermined use of prepared micro-particles for the detection of substances believed to be in a sample.

What is claimed is:

1. A method for the determination of substances in a liquid or gaseous sample, comprising the steps of:
assigning in a quasi-abstract manner a number of different size classes of micro-particles to the corresponding number of substances assumed to be in the sample,
adding to the sample amounts of so selected microparticles provided with binding partners of one of the assumed substances based on the size classes, wherein in the sample in a subsequent hybridization phase the individual binding partners of the micro-particles bind themselves in accordance with the assignment each to a substance-specific agent of the substance actually present in the sample such that the sizes of those micro-particles increase,
conducting the sample subsequently in a measuring cuvette through a measuring channel of a configuration which permits the individual passage of micro-particles, whereby a light beam passing through the measuring channel is differently attenuated depending on the size of the hybridized or non-hybridized micro-particles passing in succession through the measuring channel, which is detected by a light attenuation sensor and converted into a micro-particle size signal corresponding to the respective attenuation, and
comparing in an evaluation unit the values of the microparticle size signals with the size values of the original micro-particles size classes and,
with the determination of an increase in the size of the micro-particles over the size class values in accordance with the original assignment of micro-particle size classes determining the presence of the assumed substances in the sample.

2. A method according to claim 1, wherein as information concerning the result of a sample analysis, the names of the substances determined to be present in the sample are indicated on the analysis apparatus.

3. A method according to claim 1, wherein, after the hybridization phase substance-specific agents which are not bound to a binding partner are removed from the sample in a washing procedure.

4. A method according to claim 1, wherein, for an additional size increase of constructs formed by the hybridization of a micro-particle and substance-specific agents bound to its binding partner, amounts of corresponding binding partners are added to the already hybridized sample for the binding therof in an additional hybridization phase to the substance-specific agents bound earlier to the binding partners of these microparticles.

5. A method according to claim 1, wherein for the determination of pathogens, antibodies corresponding to those pathogens are used as binding partners.

6. A method according to claim 1, wherein for the determination of antibodies, the corresponding pathogens are used as binding partners.

7. A method according to claim 1, wherein said microparticles, in addition to their preparation during the hybridization phase for a size increase are also prepared for the emission of light after the hybridization is completed.

8. A method according to claim 7, wherein the microparticles are prepared for the emission of fluorescence light.

9. A method according to claim 8, wherein for the emission fluorescence light, the micro-particles are charged with marker particles.

10. A method according to claim 7, wherein a further light beam illuminating the measuring channel is provided which, upon striking a hybridized particle, initiates the emission of a marker-defined fluorescence light, which is detected by a respective fluorescence light measurement sensor and is transmitted as a fluorescence light signal also to the evaluation device.

11. A method according to claim 9, wherein the values of the micro-particle size and the fluorescence light signals which are detected on the basis of the same hybridized particles are compared with the size classes of the initial micro-particles size classes and, if it is found that the size of the micro-particles has been increased over that of the initial micro-particle size classes based on the initial assignment of micro-particle size classes to substances assumed to be present in the sample, the substances actually present in the sample are determined for further information procedures.

12. A method according to claim 6, wherein the emission of fluorescence light is caused by the light beam used for the size measurements of the micro-particles.

13. A method according to claim 12, wherein the light beam is a laser light beam.

14. A method according to claim 13, wherein two different laser light beams are provided which additionally may have different wavelengths.

15. A method according to claim 14, wherein fluorescence light of different wavelength is used.

16. A method according to claim 1, wherein the microparticles consist of latex.

17. A method according to claim 16, wherein microparticles are spherical and have a diameter of 2 μm to 150 μm.
